(19) United States
(12) Patent Application Publication
(10) Pub. No.: US 2017/0241390 A1
(43) Pub. Date: Aug. 24, 2017

(54) INJECTOR UNIT AND SPARK PLUG

(71) Applicant: IMAGINEERING ,INC., Kobe-shi, Hyogo (JP)

(72) Inventors: Yuji IKEDA, Kobe-shi (JP); Minoru MAKITA, Kobe-shi (JP)

(73) Assignee: Imagineering, Inc., Kobe-shi, Hyogo (JP)

(21) Appl. No.: 15/501,549

(22) PCT Filed: Aug. 4, 2015
(86) PCT No.: PCT/JP2015/072031

§ 371 Date: Feb. 3, 2017

(30) Foreign Application Priority Data
Aug. 4, 2014 (JP) 2014-159101
Aug. 6, 2014 (JP) 2014-160899

(51) Int. Cl. F02M 57/06; F02P 3/01

(52) U.S. Cl. CPC F02M 57/06; F02P 3/01

(57) ABSTRACT

An injector unit that can use a gaseous fuel such as CNG in an already-existing diesel engine and a spark plug that uses the injector unit, are provided. The injector unit includes an injector, an igniter having a resonance structure configured to boost an inputted microwave and a discharger configured to perform a discharge, and a casing configured to house therein the injector and the igniter. The igniter includes a first part configured to transmit the inputted microwave, a second part configured to perform a capacity coupling to attain an impedance matching between the microwave and the igniter, and a third part configured to transmit the capacity-coupled microwave to the discharger. Moreover, the igniter is bent at a boundary of the first part and the second part, a boundary of the second part and the third part, or inside the first part.

### TECHNICAL FIELD

The present invention relates to an injector unit, specifically, an injector unit for being usable of gaseous fuel such as CNG, i.e., Compressed Natural Gas in an already-existing diesel engine. The present invention also relates to a spark plug used for such an injector unit.

### BACKGROUND ART

As the method to reduce the diesel exhaust gas, there is a “retrofit” technique. “Retrofit” technique improves the engine exhaust emission performance by changing or adding parts to the already-existing engine. For example, EPA (Environmental Protection Agency) in United States of America recommends such a “retrofit” technique (non-patent document 1). The “retrofit” technique is also called as “Aftermarket”.

As the method to reduce the diesel exhaust gas, the change of fuel from the diesel oil to CNG is also effective. The change from the diesel oil injector to the CNG injector can also be considered.

However, CNG has an ignition temperature in higher than the diesel oil one. Therefore, ignition cannot be performed by solely changing the injector. Accordingly, it is considered that the diesel oil is used as pilot, or ignition means such as the spark plug is used together simultaneously (non-patent document 2). Non-patent document 1 is applied for the former example, and non-patent documents 2 and 3 are applied for the latter example.

### PRIOR ART DOCUMENTS

### Patent Document(s)

Non-Patent Document 1: http://www.epa.gov/cleandiesel/technologies/index.htm (United States of America EPA website, searched on May 30th, 2014)
Non-Patent Document 2: Development of Large Gas Engine with High Efficiency (Mitsui Engineering & Shipbuilding Co., Ltd. (MES) technical review No. 191(2007-6), page 19-25)
Patent Document 1: Japanese unexamined patent application publication No. 2012-149537
Patent Document 2: US unexamined patent application publication No. 2012-103302
Patent Document 3: US Patent No. 8091528
Patent Document 4: US Patent No. 7963262
Patent Document 5: Japanese unexamined patent application publication No. 2007-113570
Patent Document 6: WO(WIPO) publication No. 2012/005201

### SUMMARY OF INVENTION

### Problem to be Solved by Invention

However, if the structure of patent document 1 is adopted, both a tank for the diesel oil and a tank for natural gas are required to be mounted in an automobile vehicle. Therefore, the vehicle weight becomes heavier, and the maintenance load increases. Moreover, both the diesel oil supply and the natural gas supply are required for being taken into consideration, and this is complicated for a vehicle operator.

According to the structure of patent document 2, a separate injector is required for being mounted at an intake manifold side, and a hole for inserting an injector is required for being processed. Therefore, this technique is not applied to “retrofit” technique.

Supposing the structure of patent document 3 is adopted, there is no requirement for providing a hole to a manifold; however, the structure is complicated and high in cost performance, and therefore, this technique is also not applied to “retrofit” technique.

The present invention is made in viewpoint of the above points.

### Means to Solve the Problems

An injector unit of the present invention comprises an injector, an igniter having a resonance structure configured to boost an inputted microwave and a discharger configured to perform a discharge, and a casing configured to house therein the injector and the igniter. The igniter comprises a first part configured to transmit the inputted microwave, a second part configured to perform a capacity coupling to attain an impedance matching between the microwave and the igniter, and a third part configured to transmit the capacity-coupled microwave to the discharger, and the igniter is bent at a boundary of the first part and the second part, a boundary of the second part and the third part, or inside the first part.

### Effect of Invention

According to an injector unit of the present invention, a gaseous fuel such as CNG can be used in an already-existing diesel engine.

### BRIEF DESCRIPTION OF FIGURES

FIG. 1 is a view that illustrates a structure of an injector unit 1.

FIG. 1(a) is a front view of a partial section, FIG. 1(b) is a side view, FIG. 1(c) is a back view, FIG. 1(d) is a plan view, and FIG. 1(e) is a bottom view.

FIG. 2 is a view of a structure of an igniter 3. FIG. 2(a) is a front view, and FIG. 2(b) is a sectional front view.

FIG. 3 illustrates an equivalent circuit of the igniter 3.

FIG. 4 illustrates other structural example of the injector unit 1.

FIG. 5 illustrates another structural example of the injector unit 1.

FIG. 6 illustrates further another structural example of the injector unit 1.

### EMBODIMENTS FOR IMPLEMENTING THE INVENTION

In below, embodiments of the present invention are described in details based on figures. Note that, following embodiments are essentially preferable examples, and the scope of the present invention, the application, or the use is not intended to be limited.

### First Embodiment

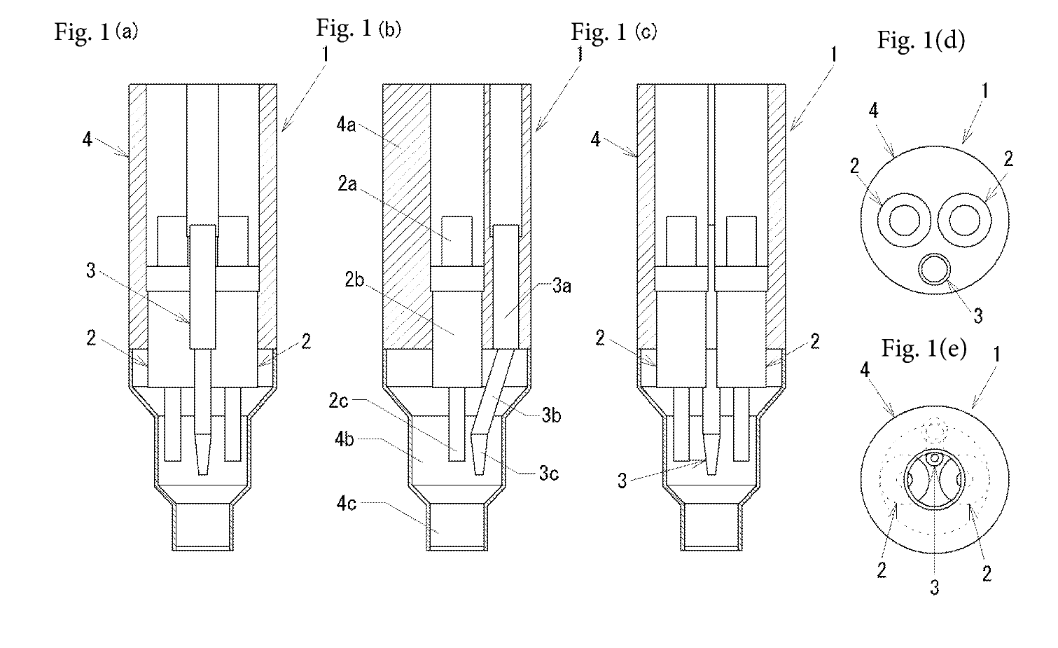

FIG. 1 is a view that shows the structure of an injector unit 1. FIG. 1(a) is a front view of a partial section, FIG. 1(b) is a side view of the partial section, FIG. 1(c) is a back view, FIG. 1(d) is a plan view, and FIG. 1(e) is a bottom view. As illustrated in FIG.1, the injector unit 1 includes two CNG injectors 2, 2 configured to inject CNG that is a kind of gaseous fuels, an igniter 3, and a casing 4 to house therein the injectors and the igniter.

The injector 2 is a solenoid injector that is broadly used as an injector for a port injection. By referring to FIG. 1(a), the injector 2 includes a rear part 2a configured to store a filter and etc. inside, a center part 2b configured to store a solenoid for driving a needle valve, and etc. inside, and a tip part 2c configured to arrange the needle valve, a nozzle, and etc. The diameter of the center part 2b is larger than that of the tip part 2c, and typically, more than twice.

The igniter 3 is one kind of ignition means for igniting CNG. The igniter 3 is one kind of spark plugs that generate high voltage by the boosting system through a resonator and perform the discharge. By the discharge, electrons are released from the gaseous molecules existed in the neighborhood, and unbalanced plasma, i.e., non local thermodynamic equilibrium plasma is generated. Thereby, the fuel is ignited. CNG has an ignition temperature higher than the temperature of the diesel oil, and the compression self ignition is difficult. Therefore, in the injector unit 1 of the present invention, the igniter 3 is used for assisting the ignition.

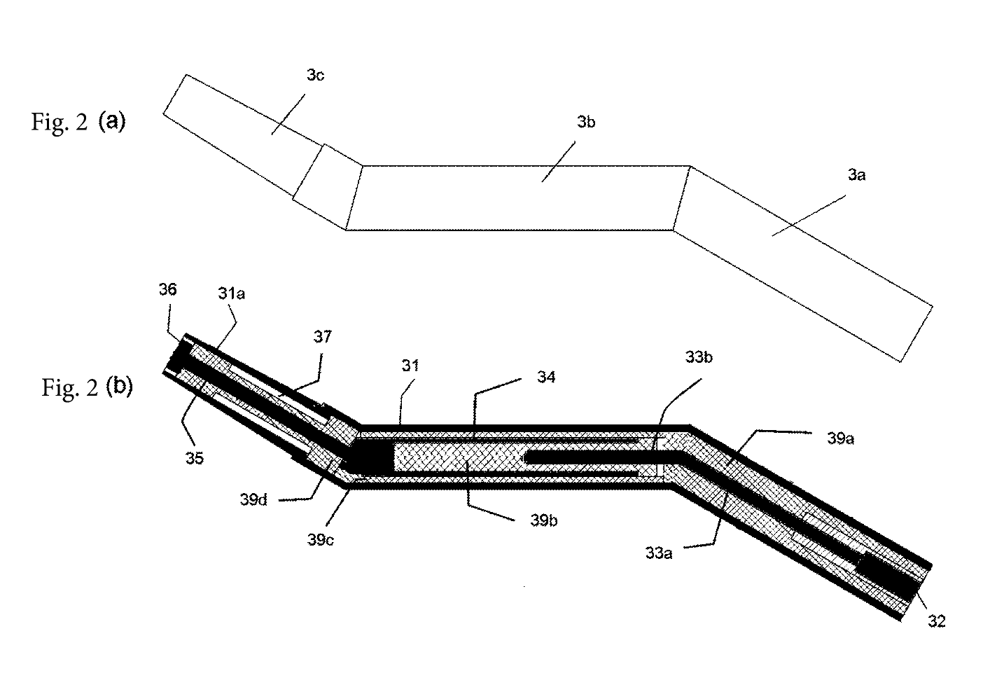

By referring to FIG. 1(a) and FIG. 2(a), the igniter 3 is divided into an input part 3a configured to input a microwave, a coupling part 3b configured to perform the capacity coupling for the purpose of, for example, attaining an impedance matching between the microwave and the igniter 3, and an amplification/discharge part 3c configured to amplify the voltage and perform the discharge. By referring to FIG. 1(b), the igniter 3 is bent at a boundary of the input part 3a and the coupling part 3b and a boundary of the coupling part 3b and the amplification/discharge part 3c. Each member of the igniter 3 is housed in a case 31 that is composed of metal having the conductivity. The structure of the igniter 3 is described in details below.

The casing 4 is a cylindrical member that includes a plurality of cylindrical parts. As illustrated in FIG. 1(a), the casing 4 is divided into a rear part 4a, a center part 4b, and a tip part 4c. The diameters of respective parts are gradually smaller in 4a, 4b, and 4c order. Here, by referring to FIG. 1(d) or FIG. 1(e), two injectors 2 are positioned in point symmetry with regard to the center of the casing 4. The igniter 3 is positioned in a direction intersecting with a line that connects the injector 2A to the injector 2B.

The injector unit 1 is, entirely, i.e., with the state of including the casing 4 (together with the casing 4), inserted into a cylinder head of the diesel engine that is one kind of compression self ignition system engines. The casing 4 is constituted of metal that has a high thermal conductivity, in relation to heat release of CNG injector 2 and igniter 3. Accordingly, in fact, the injector 2 and the igniter 3 are hidden inside the casing 4, and therefore, they cannot be visually recognized when the injector unit 1 is seen from, for example, the front. However, the casing 4 is illustrated as transparent in the figure for convenience of explanation.

In an example of FIG. 1, the rear part 2a and the center part 2b of the injector 2 are arranged in the rear part 4a of the casing 4, and the tip part 2c is arranged in the center part 4b. Moreover, the input part 3a of the igniter 3 is arranged in the rear part 4a of the casing 4. The coupling part 3b is arranged on the way of extension from the rear part 4a to the center part 4b. The amplification/discharge part 3c is arranged in the center part 4b.

The injector 2 has a larger diameter in the center part 2b, compared to the tip part 2c. Therefore, if the igniter 3 has a straight type as an usual igniter, the input part 3a of the igniter 3 and the center part 2b of the injector are interfered with each other. On the other hand, in the present invention, since the igniter 3 is bent, the input part 3a and the center part 2b are not interfered with each other.

In other words, if the igniter 3 has a straight type, the amplification/discharge part 3c cannot be arranged in the center part 4b of the casing, and there is no choice but to arrange in the rear part 4a. As a result, the discharge occurs at the rear side from an injection port of the injector 2, and therefore, it is difficult to ignite the fuel.

If two injectors 2 are aligned out of the center line (line passing through the center of casing 4), for example, if two injectors 2 are shifted to the left side of the sheet in FIG. 1(b), both of the tip part of the injector 2 and the tip part of the igniter 3 can be arranged so as to be positioned inside the center part 4b of the casing, even if the igniter 3 may not be manufactured as the bending structure. However, considering into the injection performance, two injectors 2 are preferably positioned in point symmetry with regard to the center of the casing 4. Accordingly, adoption of the bending structure of the igniter 3 contributes to the injection performance improvement of the injector 2.

Next, the structure of the igniter 3 is explained. The sectional front view of the igniter 3, FIG. 2(b) is referred to. The input part 3a includes an input terminal 32 for inputting the microwave that is generated in an outside oscillation circuit, and a first center electrode 33a. The first center electrode 33a transmits the microwave. A dielectric 39a such as ceramic is provided between the first center electrode 33a and the case 31.

The coupling part 3b includes a first center electrode 33b, and a second center electrode 34. The coupling part 3b is provided for mainly aiming to attain an impedance matching between the oscillation circuit and the igniter 3. The first electrode 33b is connected to the first electrode 33a, and it bends at a connection point. The second electrode 34 has a cylindrical structure that includes a bottom part at the amplification/discharge part 3c side. The cylindrical part surrounds around the first center electrode 33b. The stick type first center electrode 33b opposes to the inner wall of the cylindrical second center electrode 34. In this opposing portion, the microwave from the first center electrode 33 is transmitted to the second center electrode 34 by capacity-coupling. In the cylindrical part of the second center electrode 34, a dielectric 39b such as ceramic is filled, and a dielectric 39a such as ceramic is provided between the second center electrode 34 and the case 31.

The amplification/discharge part 3c includes a third center electrode 35, and a discharge electrode 36. The center electrode 35 is connected to the second center electrode 34, and the microwave of the second center electrode 34 is transmitted. The discharge electrode 36 is mounted to the tip end of the third center electrode 35. The third center electrode 35 behaves as a coil element in this situation, and a potential of the microwave gradually becomes higher with passage of the third center electrode 35. As a result, several tens of kilovolts of high voltage occurs between the discharge electrode 36 and the case 31, and the discharge is caused between the discharge electrode 36 and the case 31.

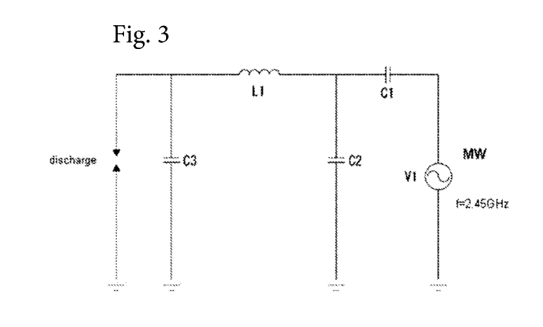

FIG. 3 is a view that illustrates an equivalent circuit of the igniter 3. The microwave (voltage V1, frequency 2.45 GHz) inputted from the outside oscillation circuit (MW) is connected to a resonation circuit that is constituted of a capacitor C3, a reactance L, and a capacitor C2 via a capacitor C1. Moreover, a discharger is provided in parallel with the capacitor C3.

Here, C1 corresponds to a coupling capacity, and C1 is determined mainly by a positional relationship between the second center electrode 34 and the first center electrode 33 (distance between both electrodes and area determined by the mutually opposing portion) and a material filled between the electrodes, in the present embodiment, a dielectric 39b having the ceramic structure. The first center electrode 33 may be constituted to move in an axial direction in order to adjust the impedance easily.

The capacitor C2 is a ground capacitance formed by the second center electrode 34 and the case 31. C2 is determined by the distance between the second center electrode 34 and the case 31, the area determined by mutually opposing portion, and a dielectric constant of the dielectric 39c. The case 31 is formed by the conductive metal, and functions also as the ground electrode.

Reactance L corresponds to a coil element of the third center electrode 35.

The capacitor C3 is a discharge capacitance formed by the third center electrode 35, the discharge electrode 36, and the case 31. C3 is determined by such as (1) shape and size of the discharge electrode 36, and distance between the discharge electrode 36 and the case 31, (2) distance between the third center electrode 35 and the case 31, and (3) space (air layer) 37 provided between the third center electrode 35 and the case 31 and thickness of the dielectric 39d. If C2>>C3, the potential difference between the both ends of the capacitor C3 can sufficiently become larger than V1. As a result, the discharge electrode 36 can become high in an electric potential. Further, since C3 can become smaller, the area of the capacitor can be made small. Of the third center electrode 35 and the case 31, the capacitor C3 is substantially determined by opposing portion under the-dielectric 39d-sandwitched-state. Conversely, the capacitor C3 can be adjusted by changing the length in the axial direction of the space (air layer) 37.

If the coupling capacitor C1 is considered to be small sufficiently, the capacitor C3, the reactance L, the capacitance C2, form a series resonance circuit, and the resonance frequency f can be expressed in a mathematical formula 1:

$$f = \frac{1}{2 π \sqrt{LC}} \qquad ( formula 1 )$$

In the formula 1,

$$\frac{1}{C} = \frac{1}{{C}_{2}} + \frac{1}{{C}_{3}}$$

In short, if f=2.45 GHz, the igniter 3 is designed such that the discharge capacitance C3, the coil reactance L, and the ground capacitance C2 satisfy the relationship of the formula 1.

As described above, the igniter 3 generates the voltage Vc3 higher than the source voltage (voltage V1 of microwave inputted into the igniter 3), based on the boosting system by the resonator. Thereby, the discharge is caused between the discharge electrode 36 and the ground electrode (case 31). When the discharge voltage exceeds the breakdown voltage of the gaseous molecules existed in the neighborhood, electrons are released from the gaseous molecules, non local thermodynamic equilibrium plasma is generated, and the fuel is ignited.

Moreover, since the frequency band of 2.45 GHz is used, the capacitance of the capacitor can be made small, and the igniter 3 has advantage for downsizing. Further, as a result that the boosting system is adopted, only the vicinity of the discharge electrode 36 of the igniter 3 becomes high in electric potential, and therefore the isolation characteristics is prominent and superior. From these points, the igniter in the present invention is superior to the conventional-resonance-structure-igniter (for example, Patent document 4).

Further, since the igniter 3 adopts a bending structure, the igniter can be inserted into a narrow space such as an injector unit 1 of the present invention.

Note that, the igniter 3 is bent at the boundary of the input part 3a and the coupling part 3b, and the boundary of the coupling part 3b and the amplification/discharge part 3c. If the igniter 3 is bent at the coupling part 3b, a distribution of the size of the capacity coupling between the first center electrode 33 and the second center electrode 34 does not become in an axial symmetry. As a result, the discharge caused by the discharge electrode 36 has a directivity, and therefore, it is undesirable. Moreover, supposing the cylindrical member, the second center electrode 34 is bent, manufacturing is difficult.

On the other hand, the first center electrode 33 and the second center electrode 34 are not opposed with each other at the boundary of the input part 3a and the coupling part 3b. Therefore, the bending at this position does not influence so much the size of the capacity coupling between the first center electrode 33 and the second center electrode 34. Accordingly, since the design value of the igniter that is already designed can be utilized, the number of electric design steps can be reduced.

Note that, the bending portion of the above igniter 3 has a horn shape; however, it may be R shape, i.e., being bent in gentle round shape.

### Second Embodiment

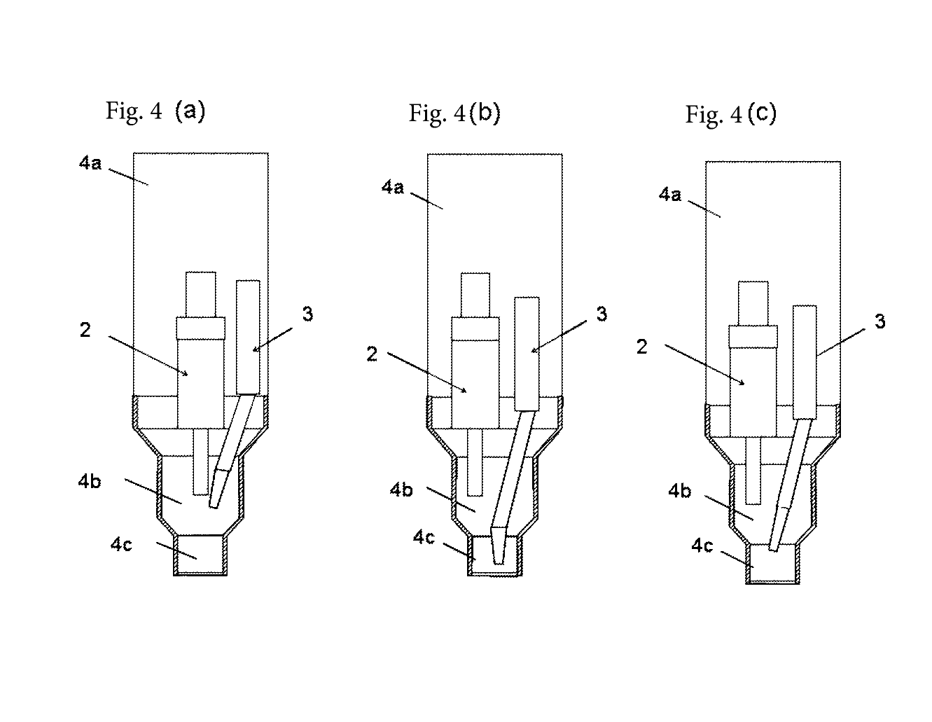

An embodiment illustrated in FIG. 4 can be considered.

As illustrated in FIG. 4(a), the igniter 3 having only one bending portion may be used. According to this configuration, the discharging position of the igniter can be closed to the jet stream of the injector. Note that, the igniter 3 has a bending portion at the boundary of the input part 3a and the coupling part 3b, and is not bent at the boundary of the coupling part 3b and the amplification/discharge part 3c.

As illustrated in FIG. 4(b), the igniter 3 configured to increase the length of the coupling part 3b may be used. According to this configuration, the tip part of the injector and the tip part of the igniter can be arranged in the tip part 4c of the casing 4, and the injection port of the injector and the discharger of the igniter can be approached to the combustion chamber. Thereby, an ignition performance by the injector unit 1 can be enhanced. Note that, the igniter 3 extends the length of the part of the first center electrode 33b that does not oppose to the second center electrode 34.

As illustrated in FIG. 4(c), the igniter 3 configured to increase the length of the coupling part 3b and be bent at only one position, may be used. According to this configuration, the injection port of the injector can be approached to the combustion chamber, and the discharging position of the igniter can be closed to the jet stream of the injector.

Which one of the above (a) to (c) is adopted depends on the shape and the size of a hole (hole for injector insertion) of the cylinder head into which the injector unit 1 is mounted. The igniter of the present invention can be bent, and the length can be changed. Therefore, it is easier for coping with various kinds of cylinder heads. Specifically, if the injector unit 1 is used for “retrofit”, it is required to be coped with various types of cylinder heads of diesel engines, and designing an individual igniter in accordance to each engine is complicated. However, according to the igniter of the present invention, it is bent at a position that does not affect to the electric characteristics, or length adjustment is performed, and therefore, various shapes of igniters can be designed without increasing significantly the number of electric design steps. As a result, a development cost can be reduced, eventually cost reduction of products can be achieved, and thereby, purchasers receive benefits therefrom.

### Third Embodiment

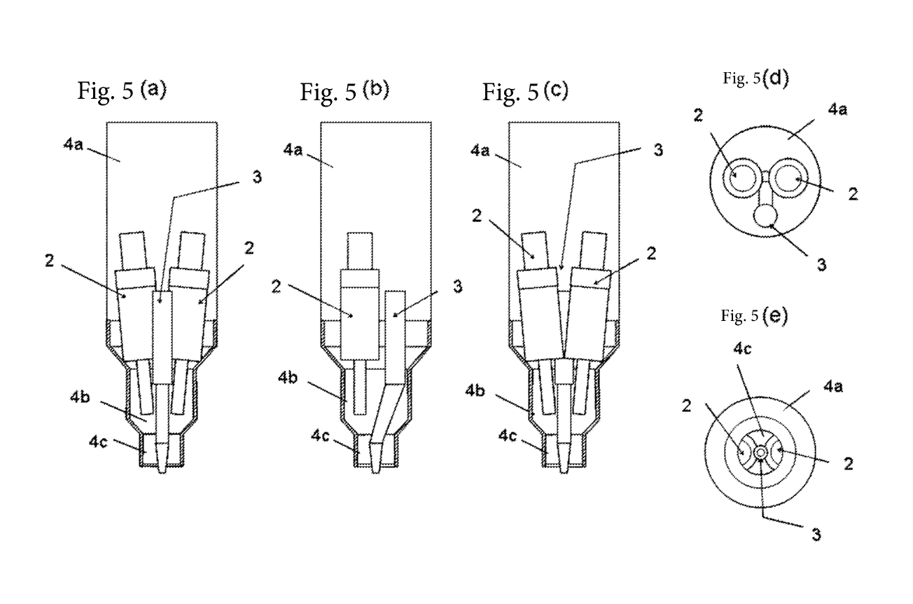

An embodiment illustrated in FIG. 5 can be considered. FIG. 5(a) is a front view of a partial section, FIG. 5(b) is a side view of the partial section, FIG. 5(c) is a back view, FIG. 5(d) is a plan view, and FIG. 5(e) is a bottom view.

In the first and second embodiments, the tip part (amplification/discharge part 3c) of the igniter 3 is aligned out of the center axis of the casing 4; however, in the present embodiment, the tip part of the igniter 3 exists on the center axis line of the casing 4.

If the igniter 3 is constituted to be straight as an usual igniter, the input part 3a of the igniter 3 and the center part 2b of the injector are interfered with each other. Therefore, the tip part of the igniter 3 cannot be arranged on the center axis line of the casing.

On the other hand, since the igniter 3 of the present embodiment is bent, the igniter 3 and the injector 2 are not interfered with each other, and the tip part of the igniter 3 can be arranged on the center axis line of the casing. That is, since the discharge by the igniter 3 is performed in the center of the casing, the fuel ignition performance can be improved.

### Fourth Embodiment

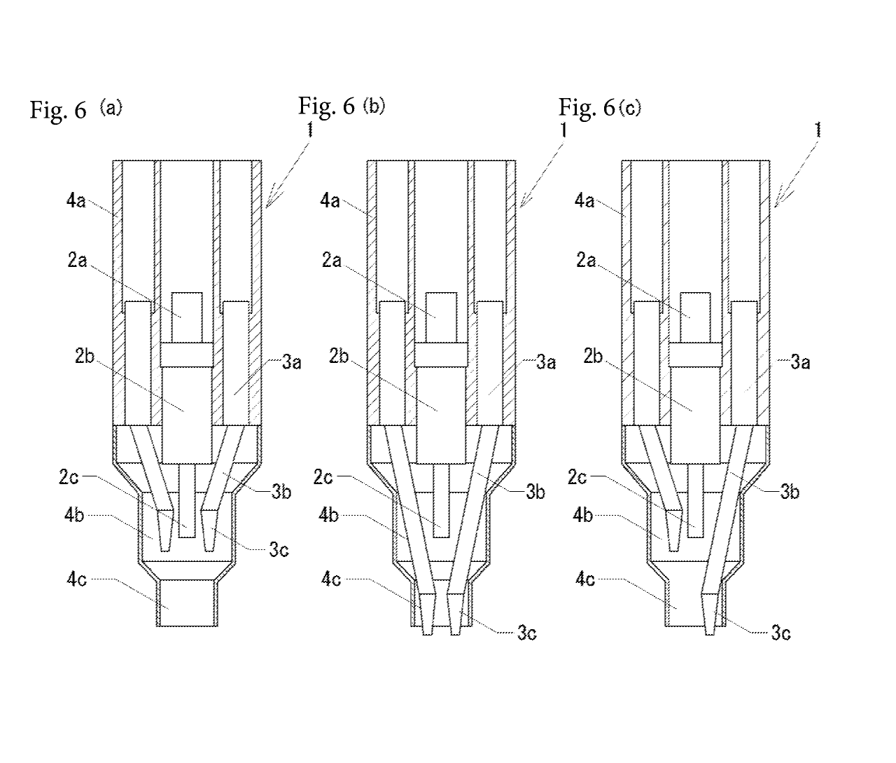

An embodiment illustrated in FIG. 6 can be considered. In the present embodiment, two igniters 3 are used.

As illustrated in FIG. 6(a), the tip parts (amplification/discharge part 3c) of the igniters 3 are arranged in the center part 4b of the casing 4. According to this example, the discharge can be caused by the igniters 3 in the vicinity of the injection port of the injector 2.

As illustrated in FIG. 6(b), the tip parts of the igniters 3 are exposed from the tip part 4c of the casing 4, and projected toward the inside of the combustion chamber. Thereby, the discharge by the igniters 3 can be caused, and therefore, the fuel ignition performance can be improved.

As illustrated in FIG. 6(c), one igniter of two igniters 3 is exposed from the tip part 4c of the casing 4, while the other igniter is not exposed at the tip part, and the tip part is arranged in the vicinity of the injection port of the injector 2. For example, before the fuel injection, the igniter 3 that is arranged in the vicinity of the injection port of the injector 2 is discharged. In this state, by injecting the fuel, a plasma seed is generated. Further, after fuel injection, the igniter 3 that is exposed at the tip end from the casing 4 is discharged, and the plasma seed is expanded. Thereby, the fuel ignition performance can be improved.

Note that, these embodiments are possible in implementation because of the bending structure of the igniter 3. Supposing the invented igniter is constituted to be straight as the usual igniter, the above-mentioned arrangements are impossible. That is, by using the igniter 3 having the bending structure, the fuel ignition performance can be improved.

The above is description of embodiments of the present invention. The scope of the present invention is determined based on inventions described in the claims, and not limited to the above embodiments.

### NUMERAL EXPLANATION

1 Injector Unit
2 Injector
3 Igniter
3a Input Part
3b Coupling Part
3c Amplification/Discharge Part
31 Case (Ground Electrode)
32 Microwave Input Terminal
33 First Center Electrode
34 Second Center Electrode
35 Third Center Electrode
36 Discharge Electrode
37 Space
39 Dielectric
4 Casing

1. An injector unit comprising:
an injector;
an igniter having a resonance structure configured to boost an inputted microwave and a discharger configured to perform a discharge; and
a casing configured to house therein the injector and the igniter:
wherein the igniter comprises a first part configured to transmit the inputted microwave, a second part configured to perform a capacity coupling to attain an impedance matching between the microwave and the igniter, and a third part configured to transmit the capacity-coupled microwave to the discharger, and
wherein the igniter is bent at a boundary of the first part and the second part, a boundary of the second part and the third part, or inside the first part.

2. An igniter comprising:
a discharger;
a first part configured to transmit an inputted microwave;
a second part configured to perform a capacity coupling to attain an impedance matching between the inputted microwave and the igniter; and
a third part configured to transmit the capacity-coupled microwave to the discharger; and
wherein the igniter is bent at a boundary of the first part and the second part, a boundary of the second part and the third part, or inside the first part.
